(19) United States
(12) Patent Application Publication
(10) Pub. No.: US 2014/0318372 A1
(43) Pub. Date: Oct. 30, 2014

(54) Membrane Separation Modules

(71) Applicant: Greenbelt Resources Corporation, Paso Robles, CA (US)

(72) Inventor: Floyd Butterfield, Paso Robles, CA (US)

(21) Appl. No.: 14/263,687

(22) Filed: Apr. 28, 2014

Related U.S. Application Data
(60) Provisional application No. 61/816,782, filed on Apr. 28, 2013.

(51) Int. Cl. B01D 71/02; B01D 53/26; B01D 63/06

(52) U.S. Cl. CPC B01D 71/028; B01D 63/06; B01D 53/268
USPC 96/8; 210/253; 210/258; 210/321.87; 96/9

(57) ABSTRACT

A system using membranes for separating a desired component from a liquid or gas mixture to obtain a high-concentration organic solvent, such as in a plant for fermenting a biomass feedstock (e.g., corn or sugarcane) to produce ethanol. A module for removing water from the ethanol/water mixture comprises multiple vessels or elements connected together in series and supported by a frame. Each element includes a number of flow tubes concentrically enclosing a tubular membrane leaving an annular space between the membrane's outer wall and the flow tube's inner wall. The preferred membrane is a hollow ceramic (e.g., zeolite) tube. An ethanol/water vapor is passed through the space between the tube walls, and a vacuum is pulled on the membrane's hollow core. Water molecules selectively move through the membrane. Multiple passes through a series of elements having the concentric tubes and membranes gradually reduces the water content of the ethanol.

### RELATED APPLICATION INFORMATION

This patent claims priority from Provisional Patent Application No. 61/816,782, filed Apr. 28, 2013, titled ETHANOL/WATER CERAMIC MEMBRANE SEPARATION MODULES.

### NOTICE OF COPYRIGHTS AND TRADE DRESS

A portion of the disclosure of this patent document contains material, which is subject to copyright protection. This patent document may show and/or describe matter, which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### FIELD OF THE INVENTION

The present invention relates to a system for separating a desired component from a liquid or gas mixture, and more particularly to a system that utilizes a separation membrane for removing water from an aqueous organic solvent to obtain a higher-concentration organic solvent, such as for use in the dehydration section of a plant that converts biomass feedstock such as corn or sugarcane to ethanol.

### BACKGROUND

Various technologies are known for purifying organic solvents such as by removing water from hydrous ethanol to produce anhydrous ethanol. For example, Hitachi Zosen of Osaka, Japan has developed a dehydration system using a zeolite ceramic separation membrane. The HDS® (Hitz Dehydration System) from Hitachi Zosen uses a specially designed high-performance zeolite membrane to extract high-purity dehydrated ethanol from hydrous ethanol. The zeolite membrane and associated components are described in U.S. Patent Publication No. 2011/0174722 to Yano, et al.

Despite certain advances in this area, there remains a need for a more cost-effective implementation.

### SUMMARY OF THE INVENTION

The present application discloses a system for separating a desired component from a liquid or gas mixture, and more particularly to a system that utilizes a separation membrane to remove water from an aqueous organic solvent to obtain a high-concentration organic solvent. One application for such a system is in a plant that ferments a biomass feedstock such as corn or sugarcane to produce ethanol. There are numerous other applications contemplated, such as gas separations or liquid separations, in a wide range of industries—biofuels, water purification, hydrocarbon separation, acid-gas separation, etc.

The disclosed system utilizes a plurality of similar units of mostly off-the-shelf parts which reduces the cost to construct in contrast with previous designs requiring a custom build approach for each system. Instead of combining a large number of membranes into one large vessel, the present system uses a series of repeating smaller vessels each with multiple membranes (e.g., 3-8) that together form an overall module. For example, instead of placing 48 membranes in a single large custom-designed vessel, the present application contemplates using six smaller elements formed with mostly off-the-shelf parts each containing eight membranes and connected together in series.

Each vessel includes a number of flow tubes enclosing within a tubular membrane. The preferred membrane is a hollow ceramic (e.g., zeolite) tube that fits inside each flow tube, with an airspace in the annular space between the ceramic tube's outer wall and the flow tube's inner wall. An ethanol/water vapor is passed through the space between the tube walls, and a vacuum is pulled on the membrane's hollow core. Water-molecules selectively move through the membrane. Multiple passes through a series of tubes enclosing membranes gradually reduces the water content of the ethanol.

An exemplary apparatus disclosed herein comprises a module for separating water from an organic solvent. The module includes a plurality of separate vessels connected in series to permit flow of a solvent/water vapor mixture therethrough. Each vessel has an outer jacket with inlet and outlet ports at each end. A membrane housing is secured within the jacket between the inlet and outlet ports and has a plurality of flow tubes with ceramic membrane tubes concentrically positioned therein and sized to create an annular space therebetween. Solvent/water vapor mixture at a positive pressure enters the inlet port of each vessel and passes axially around each ceramic membrane within its respective flow tubes and travels to the outlet port, wherein a negative pressure gradient is applied across each membrane directed toward the inner lumen thereof so water vapor selectively permeates the membrane and steadily reduces the water content in the solvent/water vapor mixture as it progresses through the separate vessels. In one embodiment, each of the vessels has an elongated tubular configuration with the inlet and outlet ports at opposite ends and oriented either 90° or 180° from each other.

### DESCRIPTION OF THE DRAWINGS

FIG. 1 is a perspective view of an exemplary component extraction module of the present application having six elongated tubular vessels connected in series and supported by an external frame;

FIG. 1A is a perspective view of one tubular vessel for use in the component extraction module of FIG. 1, with 180° side inlet and outlet flanges;

FIG. 2A is a schematic end view and FIG. 2B is a schematic perspective view of the of the component extraction module of FIG. 1 showing the general and overall direction of flow, respectively, through the six vessels connected in series;

FIG. 2C is a schematic end view and FIG. 2D is a schematic perspective view of the of an alternative to the component extraction module of FIG. 1 showing the general and overall direction of flow, respectively, through six vessels connected both in series and parallel;

FIGS. 3A and 3B are two different perspective views of one end of the component extraction module of FIG. 1;

FIG. 4A is an enlarged perspective view of the ends of two of the tubular vessels within the component extraction module of FIG. 1, and FIG. 4B has an outer jacket removed from one of the vessels to show four inner component extraction membranes therein;

FIGS. 5A and 5B are top plan and side elevational views, respectively, of the tubular vessel of FIG. 1A;

FIG. 6 is a discontinuous sectional view of the exemplary tubular vessel taken along line B-B of FIG. 5A;

FIG. 7 is a radial sectional view through the exemplary tubular vessel taken along line A-A of FIG. 5B, and FIG. 7A is an enlargement thereof;

FIG. 8 is a vertical sectional view taken through two of four inner separation membranes in one of the tubular vessels taken along line C-C of FIG. 7;

FIG. 9 is an exploded perspective view of one end of the vessel of FIG. 1 with an end cap separated from the outer jacket to illustrate the end assembly of one of the four inner separation membranes;

FIGS. 10A and 10B are side and end elevational views of a membrane housing for receiving four inner separation membranes and their surrounding tubes; and

FIGS. 11A-11C are top, side, and end elevational views of an outer jacket of the vessel of FIG. 1A.

### DETAILED DESCRIPTION

The present application provides a component extraction module for removing a component from a mixed flow of gas or liquid (e.g., water from an ethanol/water mixture). Each module comprises a plurality of elements or vessels each having outer jackets connected together in series, parallel, or any combination thereof and supported by a frame. Of course, more or fewer “vessels” may comprise the “module,” depending on the dimensions, flow rates, incoming fluid composition and output required, among other things.

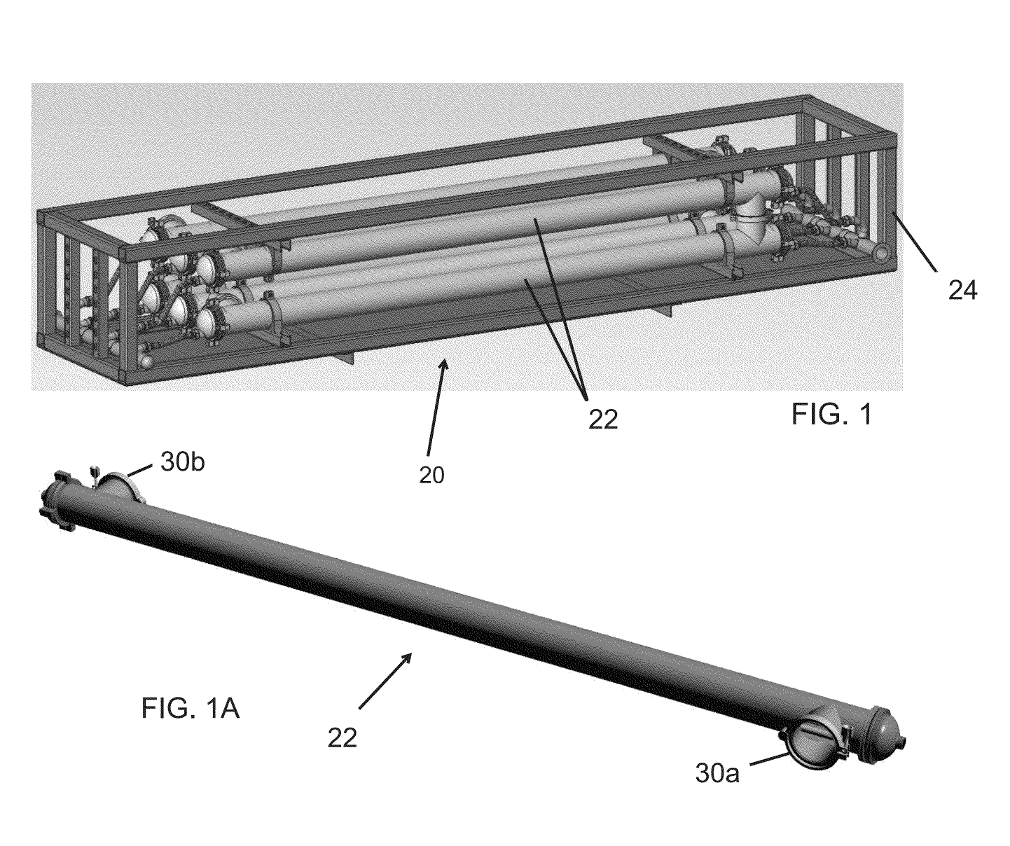

FIG. 1 is a perspective view of an exemplary component extraction module 20 of the present application having six elongated tubular vessels 22 connected in series and supported by an external frame 24. FIG. 1A illustrates a single tubular vessel 22 having inlet and outlet flanges 30a, 30b oriented 180° from each other. As will be seen below, the relative orientation inlet and outlet flanges 30 varies depending on the position of the tubular vessel 22 within the overall module 20.

As will be explained in greater detail below, each tubular vessel 22 houses a plurality of rigid flow tubes that extend longitudinally therewithin. Each of the inner flow tubes, in turn, receives a tubular membrane formed of the material that can separate water from a liquid or gas mixture to obtain a high-concentration organic solvent. The tubular membranes extend substantially the entire length of the vessels and are sealed at end caps so as to create a negative pressure gradient across the membranes and pull water inward. The tubular vessels 22 are arranged in parallel adjacent to one another and supported by the frame 24 so as to form a more compact module 20. The vessels 22 are connected in series so that the liquor or gas mixture passes through the connected inner flow tubes and the water can gradually be removed from the liquid or gas mixture.

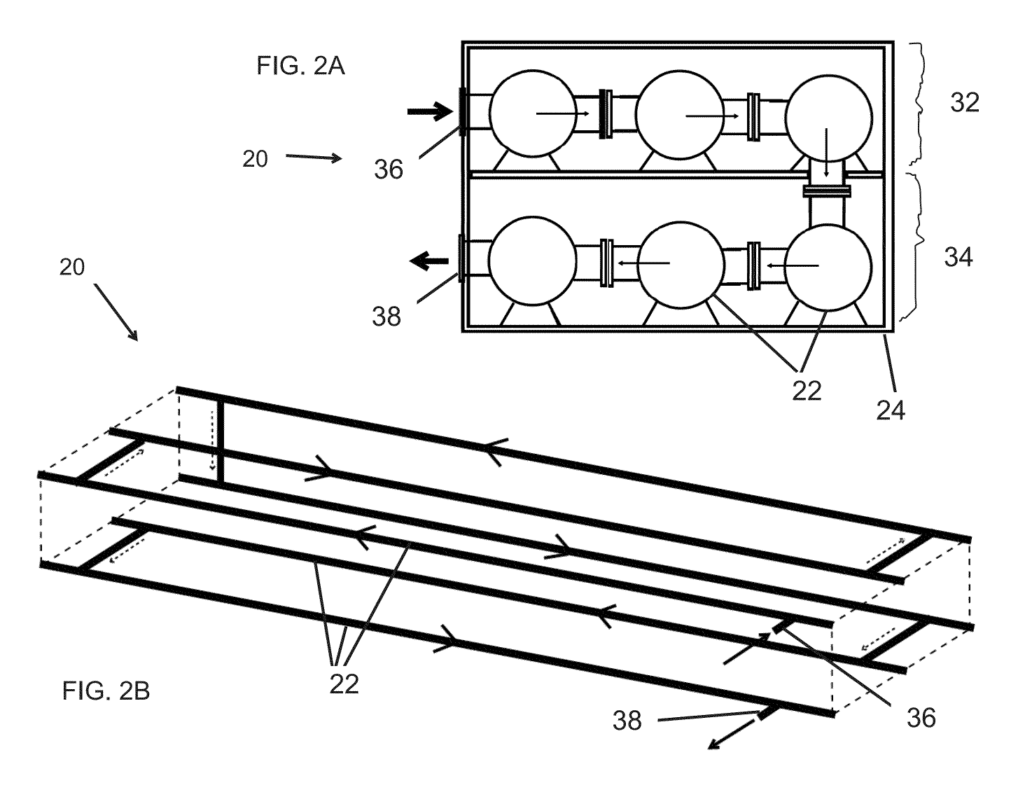

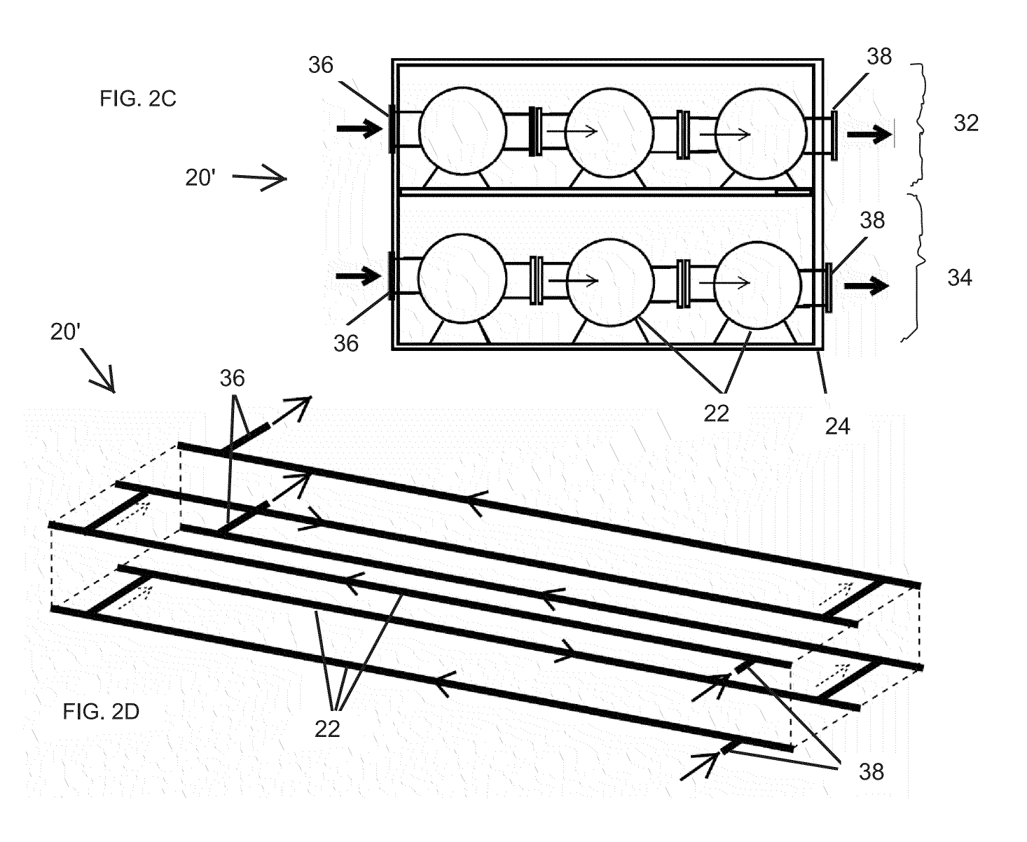

FIG. 2A is a schematic end view of the component extraction module 20 of FIG. 1 showing the general direction of flow through the six vessels 22 connected in series, while FIG. 2B is a schematic perspective view of the module showing the overall direction of flow through the six vessels connected in series. In the exemplary embodiment, the six vessels 22 are arranged in a 2×3 combination, with three of the vessels supported on an upper level 32 and three of the vessels supported on a lower level 34. The module 20 has a single inlet port 36 at one end of one of the vessels 22 on the upper level 32, and a single outlet port 38 at the same end of one of the vessels 22 on the lower level 34.

As indicated by the flow arrows in FIGS. 2A and 2B, the aqueous liquid or gas mixture enters the inlet port 36 and passes along each one of the six vessels 22 in sequence before exiting the outlet port 38. Two side flanges 30 are provided on each one of the vessels 22 to provide flow connections between the vessels. Four of the tubular vessels 22 have side flanges 30 that are oriented 180° from each other, as seen in FIG. 1A, while the other two have side flanges 30 that are oriented 90° sign from each other. These latter two vessels 22 enable flow between the upper level 32 and the lower level 34. It should be clear that the flange connections between sequential vessels 22 are at opposite ends, with the flow continuing through the module in a serpentine fashion. Details of the vessel construction as well as the placement and assembly of the membranes therein are shown in the attached figures.

As will be appreciated by those of skill in the art, the number and arrangement of the tubular vessels 22 within the module 20 may vary, such as providing all six of the tubular vessels on one level, or reversing the flow to go from the lower level 34 to the upper level 32. Likewise, the capacity of the system can be increased by increasing the number or size of vessels 22, such as by providing a 3×3 or 4×4 array. Indeed, any conceivable array configuration is possible.

An alternative component extraction module 20′ is shown in FIGS. 2C and 2D Like parts will be given like numbers. Instead of six vessels 22 in series, as above, the module 20′ has vessels 22 connected both in series and in parallel. An inlet 36 is provided at one end of an outside vessel 22 on both the upper level 32 and the lower level 34. Flow passes in series through first and second groups of three vessels 22 on each level, and exits through respective outlets 38. Although not shown, a Y-connector or other such piping to join the two inlets 36 as well as the two outlets 38 can be provided to simplify the plumbing. This configuration illustrates just one alternative, and the present application encompasses a plurality of separate vessels each having component extraction membranes therein connected in series, in parallel, or a combination of the two.

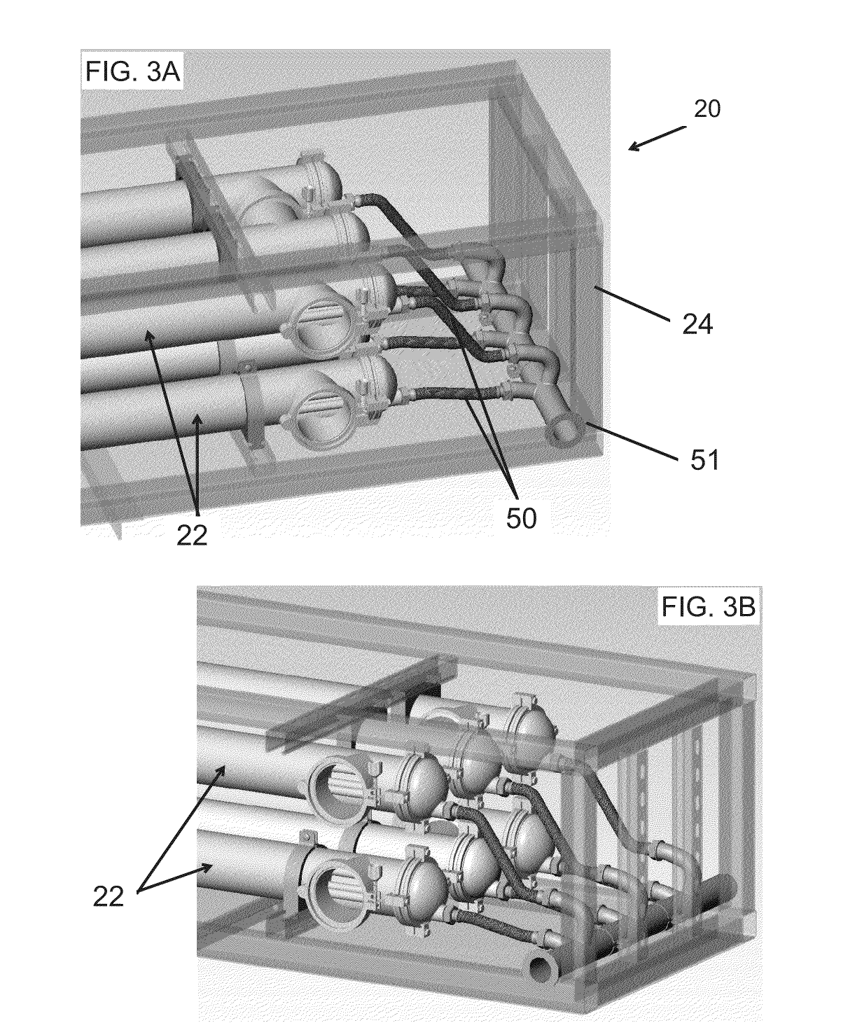

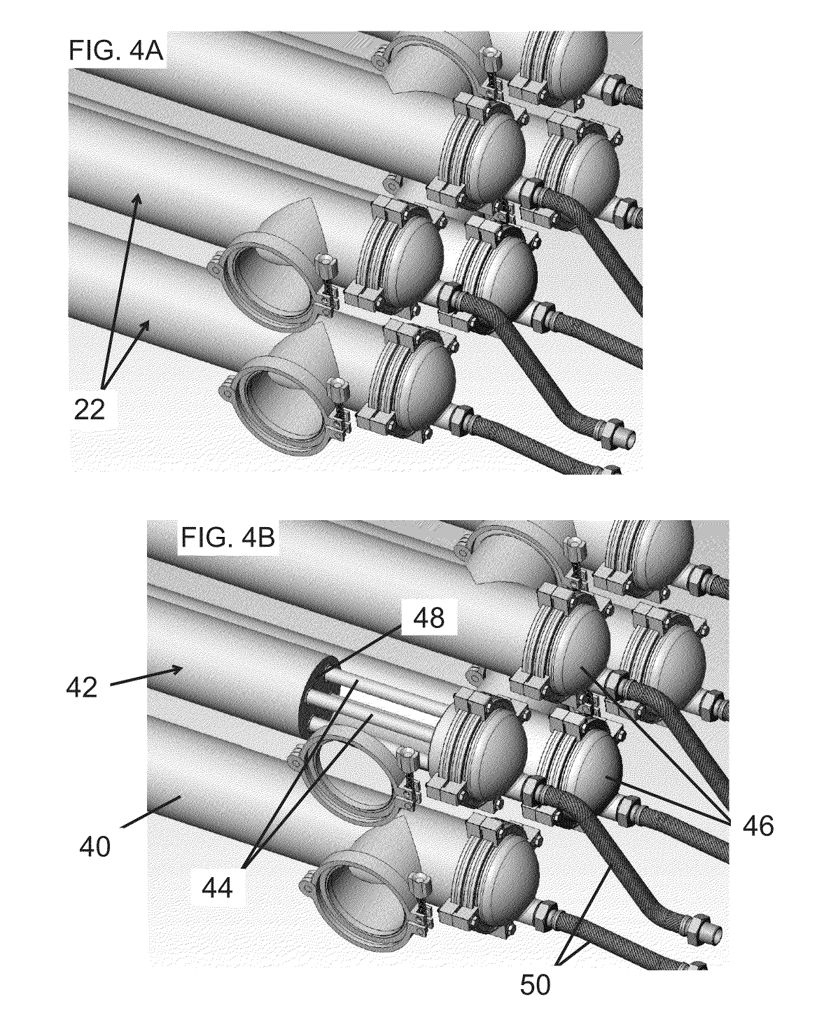

FIGS. 3A and 3B are two different perspective views of one end of the component extraction module 20 of FIG. 1. FIG. 4A is an enlarged perspective view of the ends of two of the tubular vessels 22, and FIG. 4B has an outer jacket 40 removed from one of the vessels to show a membrane housing 42 and four inner component extraction membranes 44 extending therefrom to an end cap 46. As will be explained in greater detail below, there are preferably four flow tubes provided within each membrane housing 42, which may comprise a tube (of stainless steel or other suitable material) having an OD of 4″ or greater. There may be between 1-50 of the flow tubes within each membrane housing 42, and they may be made of a variety of rigid materials (e.g., stainless steel, non-corrosive metal alloys, plastic, etc.). A tubular component extraction membrane 44 extends through each of the flow tubes such that four membranes extend to the end cap 46. The terminal ends of each of the component extraction membranes 44 are each sealed from the larger space within the vessel jacket 40. Each membrane housing 42 includes a radial plate 48 on each end to which the inner flow tubes attach. The inner diameter of each of the flow tubes is larger than the outer diameter of the component extraction membranes 44 to create an annular space therebetween. The aqueous liquid or gas can thus flow longitudinally through these four annular spaces during which time a negative pressure gradient pulls water into the central lumen of the component extraction membranes 44. A vacuum hose 50 connected to each end cap 46 maintains the negative pressure gradient and removes the separated water, collecting the aggregate in a common discharge pipe 51 (FIG. 3A). The vacuum hoses 50 comprise flow connectors that enable communication of a source of vacuum to the interior lumens of the extraction membranes 44. Desirably the hoses 50 merge into one, though other arrangements are possible.

The aqueous liquid or gas thus flows into one of the side flanges 30 of each vessel 22, coming into contact with the four exposed sections of the component extraction membranes 44. Subsequently, because of a positive flow pressure, the liquid or gas passes axially through the four annular spaces around the component extraction membranes 44 and within the flow tubes of the membrane housing 42. The liquid or gas, now somewhat dehydrated, then exits through the other flange 30 of the first vessel 22 and into the second vessel, and continues in this manner through all of the vessels.

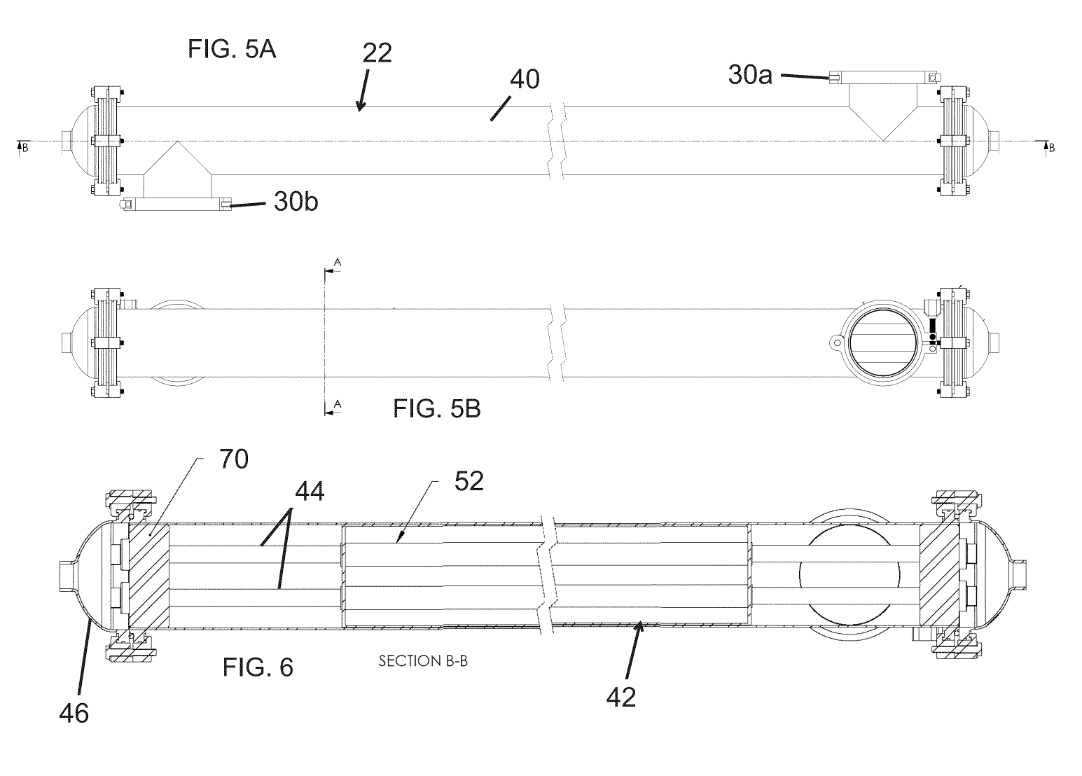

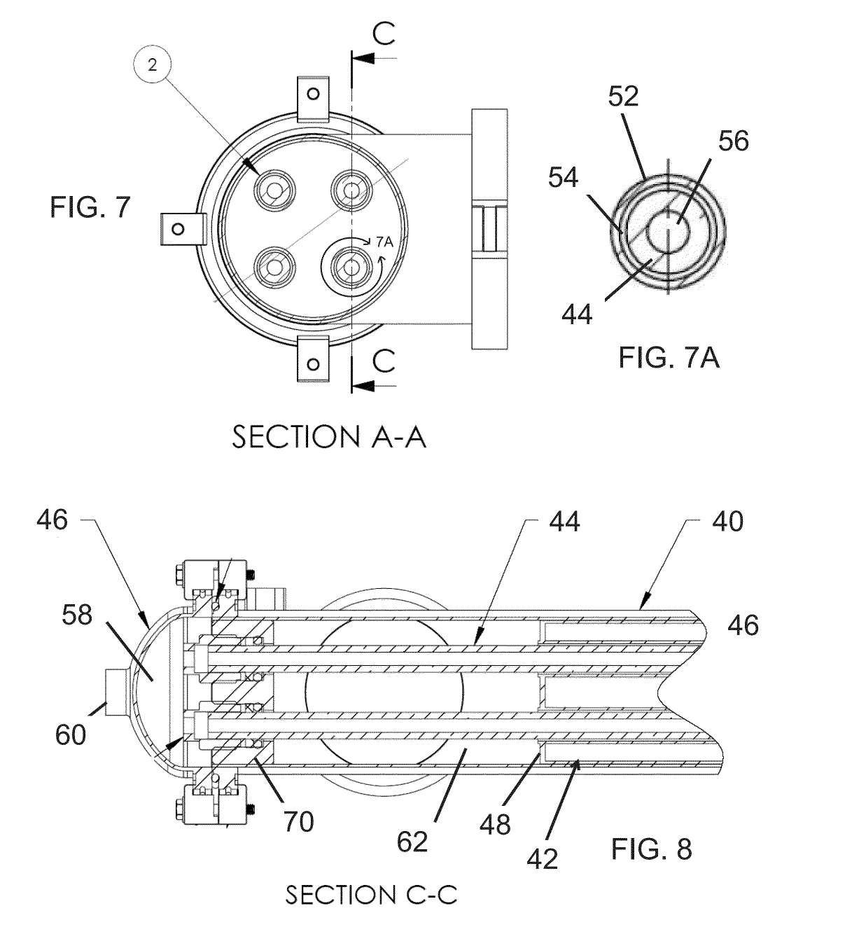

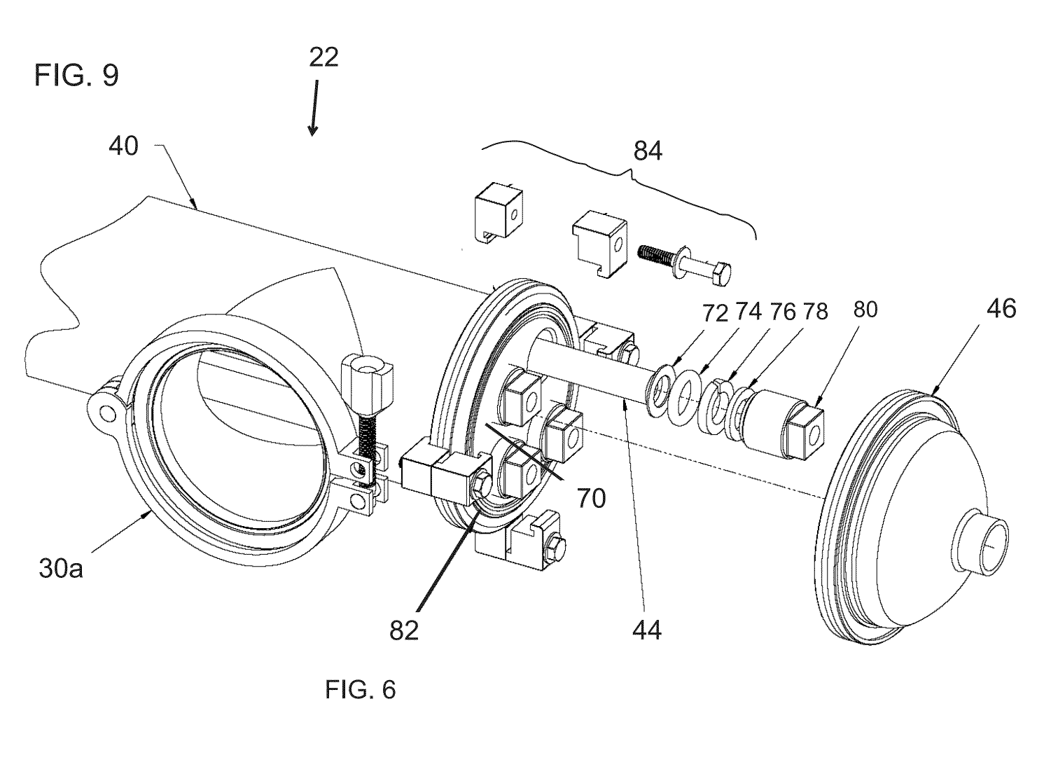

FIGS. 5-9 illustrates in greater detail components of the exemplary tubular vessel 22 of FIG. 1A. FIGS. 5A and 5B illustrate the outer jacket 40 having the two flanges 30a, 30b extending from the sides in opposite directions, and the end caps 46 secured thereto with flanges and bolts. Longitudinal section B-B from FIG. 5A as seen in FIG. 6 illustrates the membrane housing 42 within the outer jacket 40 and two of the four flow tubes 52 therein. Radial section A-A from FIG. 5B as seen in FIG. 7 again shows the four flow tubes 52 with component extraction membranes 44 positioned therein, and FIG. 7A is an enlargement that shows the annular space 54 therebetween. The aqueous liquid or gas flows through the annular space 54 and a vacuum created within the lumen 56 of the membrane 44 pulls water through the membrane.

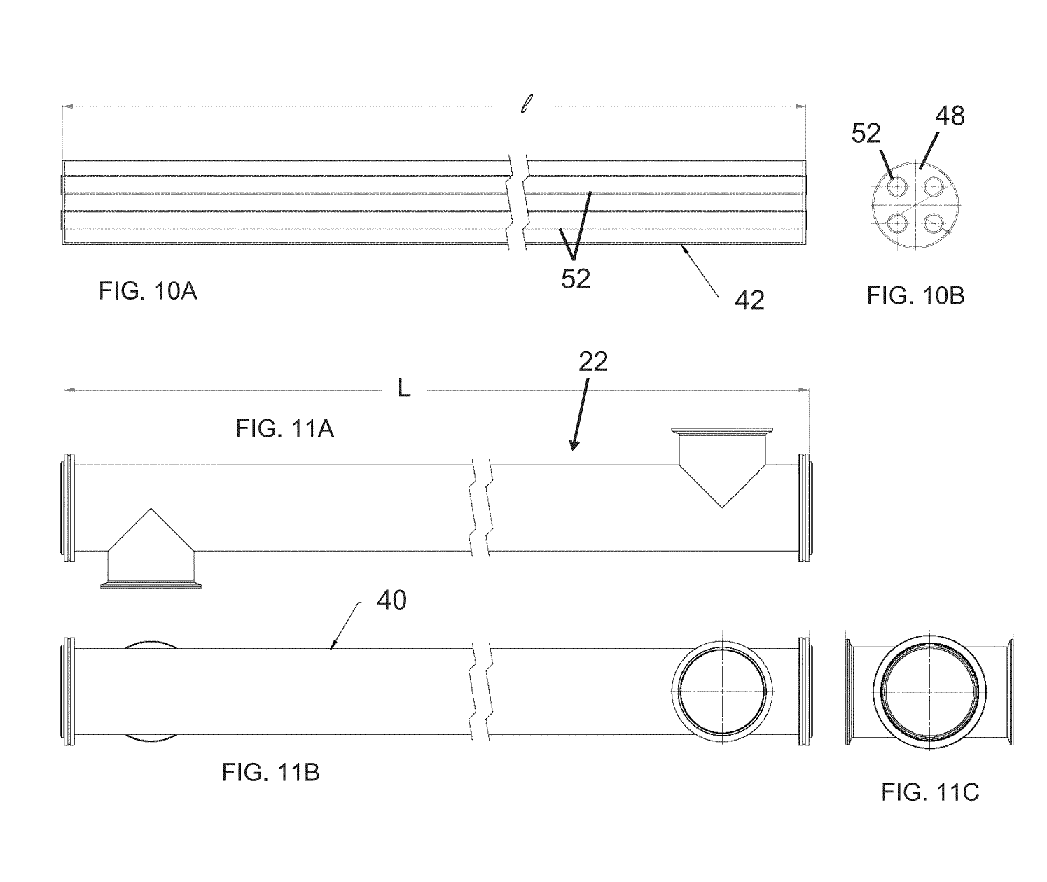

With reference to FIGS. 10-11, the overall length L of each tubular outer jacket 40 is desirably greater than 2× the length of each membrane 44, since the membranes are loaded from each end. In the exemplary embodiment, the length is about 2.2 m (i.e., greater than 2× the 1 m length of the membranes 44). The system is applicable to any membrane length. The length l of the membrane housing 42 is somewhat shorter to expose the opposite ends of the membranes 44, and in an exemplary embodiment is about 1.8 m. The outer jacket 40 is desirably tubular for the sake of economy, although other cross-sectional shapes may be used. Likewise, the inner membrane housing 42 is also desirably tubular with the radial plates 48 on each end being circular. The four flow tubes 52 are distributed evenly around the membrane housing 42 square pattern, such as seen in FIG. 10B. In the embodiment shown, the radial plate is a solid, thick, 4″ diameter stainless steel plate machined with 4 threaded holes, though it can be any diameter, with any number of holes, threaded or not threaded. No dividers are required because each group of 4 flow tubes is in a separate vessel. It is much cheaper to replicate the 4-hole plate than it is to create a larger plate for a larger vessel holding more tubes. It is more reliable and more serviceable too, because one flaw in the big plate (or any of its attached tubes) renders the entire vessel unusable, whereas a flaw in one of the small vessels only affects that vessel.

The preferred module has six 4″ OD stainless steel tubular membrane housings 42 connected in sequence within the larger jackets 40. Each 4″ tubular membrane housing 42 features four 1″ OD stainless steel flow tubes 52. Each individual membrane 44 is a hollow ceramic (e.g., zeolite) tube formed of two separate membranes of 1 m in length having ends that are in contact with each other so as to form a single tubular length of membrane 2 m long and loaded into a 1″ flow tube from each end of the membrane housing 42 to form a single membrane unit therein. The ethanol/water vapor (at about 90% ethanol, 10% water), at some positive pressure, enters the first membrane housing and travels through the annular spaces between the inner walls of the 1″ flow tubes and the outer walls of the membranes therein. A vacuum is applied to the inner core of the membrane to create a negative inward pressure gradient, and water vapor selectively permeates the membrane. The water vapor (with approximately 4% ethanol) is called permeate and can be recycled in the plant. The ethanol/water vapor passes through the six vessels 22, steadily losing water through the membranes 44. The exhaust vapor out of the 6th vessel 22 is anhydrous grade fuel ethanol (99.2%).

FIG. 8 is a vertical sectional view taken through two of four inner separation membranes 44 in one of the tubular vessels 22 taken along line C-C of FIG. 7. As mentioned previously, the component extraction membranes 44 extend axially beyond the membrane housing 42 to an end cap 46. The lumen 56 of each of the membranes 44 is open to a hemispherical chamber 58 within the end cap 46, and as mentioned a vacuum is pulled through a hose attached to a nipple 60. The ends of each of the membranes 44 are sealed from a volume 62 within the outer jacket 40 and adjacent a side flange 30. Specifics of the seal are shown exploded in FIG. 9, with the end cap 46 separated from the outer jacket 40.

Each membrane 44 passes through one of four holes in a generally circular and axially thick end plate 70. As seen in cross-section in FIG. 8, the four holes each receive a number of washers and seals (shown exploded in FIG. 9) that prevent ingress of fluid from within the inner volume 62 of the jacket to the hemispherical chamber 58. In preferred embodiments there is a relatively thin rigid (e.g., stainless steel) washer 72, an O-ring 74 of a suitable elastomer such as EPDM rubber, a second washer 76 of a polymer such as PTFE, and a relatively thick rigid (e.g., stainless steel) washer 78, all secured within the holes of the end plate 70 with a threaded sealing cap 80. A larger O-ring 82 extends around the outer edge of the end plate 70 and is sealed between two flanges of the jacket 40 and end 46 by a plurality of clamp assemblies 84.

The particular membrane material depends on the separation process. In general, the membrane would be selectively permeable for at least one component of a liquid or gas stream. Ceramics are often used to separate water from hydrous organics solvents, and some permit gasses such as CO₂ to pass through. For separation of water from hydrous ethanol, the membrane is desirably a porous tube of zeolite containing an alumina as a main component and an attachment member disposed in a connection position of the porous tube, wherein the porous tube and the attachment member are bonded by a ceramic oxide-based bonding agent containing 17 to 48 wt % of SiO₂, 2 to 8 wt % of Al₂O₃, 24 to 60 wt % of BaO, and 0.5 to 5 wt % of ZnO as essential components and containing at least one of La₂O₃, CaO, and SrO, and a zeolite layer is formed on a surface of the porous tube. For example, the separation membranes used in the HDS® (Hitz Dehydration System) from Hitachi Zosen may be suitable, as are those described in U.S. Patent Publication No. 2011/0174722 to Yano, et al., the disclosure of which is expressly incorporated by reference herein. The membrane material is hydrophilic and thus facilitates the removal of water from the vapor stream. The coating on the surface of the membrane facing the vapor stream is highly sensitive to scratching and has a significant impact on the efficacy of the membrane and its usage.

It should be noted that though the preferred membrane is hydrophilic and pulls water out of liquid, an alternative hydrophobic membrane may be used with a reverse function. That is, a membrane that prevents water passage but permits solvent passage could be used in the system with the solvent being collected in the membrane lumens.

One of the advantages of the present system is that smaller membrane “elements” (or vessels 22), can be mixed and matched to provide any number of membrane tubes and passes to create the same capacity as in the Hitz Dehydration System, which utilizes one larger vessel. For example, one system operates at a vapor supply pressure of approximately 1 psig, with a vacuum of 29″ Hg on the membrane's inner cores. The modular design includes six passes through each of 4 membrane tubes (actually 8 membranes because two are always placed end-to-end) per pass. The six elements connected together in series provided exactly the same flow path as in a large module design such as the Hitz Dehydration System, which places 24 tubes inside one outer vessel.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

It is claimed:

1. An apparatus for separating a component from a mixture, comprising:
a component extraction module including a plurality of separate vessels connected in series, parallel, or any combination thereof, each vessel having within a flow path for the mixture and a plurality of membrane elements including flow tubes with membrane tubes placed concentrically therein and sized to create an annular space therebetween, the annular space forming a part of the flow path in each vessel; and
flow connectors attached to each vessel so as to be in fluid communication with an interior lumen of the membrane tubes therein and adapted to connect to a source of vacuum for creating a negative pressure gradient across the membrane tubes toward the inner lumens thereof,
wherein when a mixture at a positive pressure enters the annular spaces around the membrane tubes and travels the length of the membrane element in each vessel, the component selectively permeates the membrane tubes in each vessel and steadily reduces the content of the component in the mixture as it progresses through the separate vessels.

2. The apparatus of claim 1, wherein the component is water and the mixture is an organic solvent.

3. The apparatus of claim 1, wherein the membrane tubes are made of a ceramic.

4. The apparatus of claim 1, wherein the membrane tubes are made of zeolyte.

5. The apparatus of claim 1, wherein the vessels are all connected in series so that the mixture passes through each one in sequence.

6. The apparatus of claim 1, wherein there are a first group of vessels connected in series so that a first portion of the mixture passes through each one in sequence, and a second group of vessels connected in series so that a second portion of the mixture passes through each one in sequence, and further including piping to combine the output from the flow paths of the first and second groups of vessels.

7. The apparatus of claim 1, wherein each vessel comprises an outer jacket with inlet and outlet ports at each end, and a membrane housing secured within the jacket between the inlet and outlet ports and having the plurality of flow tubes extending therethrough, wherein the membrane tubes extend beyond the end of the respective flow tube and past the inlet and outlet ports and are sealed therefrom.

8. The apparatus of claim 1, further including end caps at each end of the jacket to which the flow connectors attach, wherein the terminal ends of each membrane tube is open to a volume sealed within a respective end cap to enable a negative pressure to be applied to all of the membrane tubes at once.

9. The apparatus of claim 1, wherein each of the vessels has an elongated tubular configuration with inlet and outlet ports at opposite ends and oriented either 90° or 180° from each other.

10. An apparatus for separating a component from a solvent/water vapor mixture, comprising:
a component extraction module comprising a plurality of separate vessels grouped together, each configured to permit flow of a solvent/water vapor mixture therethrough along a flow path, each vessel having an outer jacket with inlet and outlet ports at each end, a membrane housing being secured within the jacket between the inlet and outlet ports and having a plurality of flow tubes with membrane tubes concentrically positioned therein and sized to create an annular space therebetween, the annular spaces forming a part of the flow path;
flow connectors attached to each vessel so as to be in fluid communication with an interior lumen of the membrane tubes therein and adapted to connect to a source of vacuum for creating a negative pressure gradient across the membrane tubes toward the inner lumen thereof,
wherein when a solvent/water vapor mixture at a positive pressure enters the inlet port of each vessel, passes axially through the annular spaces around the membrane within its respective flow tube and travels to the outlet port, the water vapor selectively permeates the membranes in each vessel and reduces the water content in the aggregate solvent/water vapor mixture as it progresses through the vessels.

11. The apparatus of claim 11, wherein the component is water and the mixture is an organic solvent.

12. The apparatus of claim 11, wherein the membrane tubes are made of a ceramic.

13. The apparatus of claim 11, wherein the membrane tubes are made of zeolyte.

14. The apparatus of claim 11, wherein the vessels are all connected in series so that the mixture passes through each one in sequence.

15. The apparatus of claim 11, wherein there are a first group of vessels connected in series so that a first portion of the mixture passes through each one in sequence, and a second group of vessels connected in series so that a second portion of the mixture passes through each one in sequence, and further including piping to combine the output from the flow paths of the first and second groups of vessels.

16. The apparatus of claim 11, wherein the membrane tubes extend beyond the end of the respective flow tube and past the inlet and outlet ports and are sealed therefrom.

17. The apparatus of claim 16, further including end caps at each end of the jacket to which the flow connectors attach, wherein the terminal ends of each membrane tube is open to a volume sealed within a respective end cap to enable a negative pressure to be applied to all of the membrane tubes at once.

18. The apparatus of claim 11, wherein each of the vessels has an elongated tubular configuration with the inlet and outlet ports at opposite ends and oriented either 90° or 180° from each other.
